(19) United States
(12) Patent Application Publication
(10) Pub. No.: US 2016/0008638 A1
(43) Pub. Date: Jan. 14, 2016

(54) FIRE ESCAPE SYSTEM

(71) Applicant: William Hafner, Huntingdon Valley, PA (US)

(72) Inventor: William Hafner, Huntingdon Valley, PA (US)

(21) Appl. No.: 14/325,759

(22) Filed: Jul. 8, 2014

(51) Int. Cl. A62B 1/06

(52) U.S. Cl. CPC A62B 1/06

(57) ABSTRACT

A fire escape system wherein anchors for rappelling are strategically placed on the different faces of a multi-story building. This system employs rappelling ropes and harnesses to be used by building occupants in the event of a fire emergency to allow efficient and safe evacuation of all occupants.

### CROSS-REFERENCE TO RELATED APPLICATIONS

Not applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present application is a regular utility application for patent. The present invention pertains to the field of fire safety, and more specifically, to the field of fire escape system design.

### BACKGROUND OF THE INVENTION

A review of other fire escape systems has shown that problems arise because of the interruption or break down of the normal operations of the building. Specifically power failure can occur preventing occupants from being warned not to use elevators, where they can become trapped. Staircases are then usually the remaining avenue left for exit but these exits can present problems because of long descents for occupants or blockages that can occur from smoke, fire or structural damage.

The prior art has put forth several designs for fire escape systems. Among these are U.S. Pat. No. 4,640,388 to Walborn which describes an escape device comprising roller spools for cables positioned near windows.

U.S. Pat. No. 4,703,831 to Forrest et al describes a fire escape apparatus for use in multi-story buildings comprising a movable rope system and expansion means for extending an arm outward from an anchor.

U.S. Pat. No. 7,195,100 to Shechter describes a system and method for an escapable multi-story building comprising a series of brackets and Cables.

U.S. Pat. No. 4,520,900 to Orgeron describes a system by which a cage or harnesses are lowered on a cable by a hydraulic brake device. This system has limitations however because it is controlled solely by the hydraulic brake it can not stop at lower levels to pick up additional evacuees and does not discuss going back up to provide repeated descents by any remaining evacuees. This means that the evacuation of other floors must be provided for in other locations of the building limiting the evacuation in this column area of the building. Even if the cage or harnesses could go backup this is a wasted motion of the system using up valuable time which is a critical element in a fire escape system and limits the efficiency of the system. Furthermore, the lack of control by the evacuees of the descent does not allow any adaptability of the evacuation to any changing conditions during the emergency situation. One instance might be that a fire broke out below with flames coming out a window. In this instance, the cage or harnesses could not be stopped at a level above the fire to allow exit but instead would continue straight through the fire.

None of these prior art references describe the present invention. This invention is intended to overcome the shortcomings and deficiencies of the prior art. In summary none of these references or prior designs for fire escape systems describe using or applying the technique of rappelling and specifically rappelling equipment devices to be employed in a fire escape system which makes this invention unique and and provides for the most versatility, flexibility, adaptability and efficiency.

### SUMMARY OF THE INVENTION

It is an object of the present invention to provide an improved fire escape system for escape from a multi-story building of any height. This system utilizes rappelling equipment devices strategically placed on the multi-story building. This system enables evacuees to be able to respond to the emergency and evacuate the building as quickly as possible.

### BRIEF DESCRIPTION OF THE DRAWINGS

FIG. 1 is a view of the preferred embodiment of the present invention shown installed on a multi-story building.

FIG. 2 is a view of an individual anchor ring shown installed at an exit point with mounting hardware.

FIG. 3 is a front view or a full body harness shown on a person preparing to rappel.

FIG. 4 is a top view of the components used to attach a full body harness to a rappelling rope.

FIG. 5 is a view of the manner of attaching a rope in preparing to rappel in the preferred embodiment of the present invention.

FIG. 6 is a depiction of all the components needed to attach a full body harness to a rope for rappelling.

FIG. 7 is a rear view of method of a double body harness for attaching a handicapped person to the back another's body harness and the manner of connection in the preferred embodiment.

FIG. 8 is a close up of the attachment of the double body harness.

FIG. 9 is a rear view of an escapee attaching a child or pet to the back of their body harness and the manner of connection in the preferred embodiment.

FIG. 10 is a rear view of a child in a harness for attachment to an adult in a body harness,

FIG. 11 is a side view of a dog in a harness for attachment to an adult in a body harness.

FIG. 12 is a close up of the attachment of the adult body harness and a secondary harness, such as those shown in FIGS. 10 and 11.

### DETAILED DESCRIPTION OF THE INVENTION

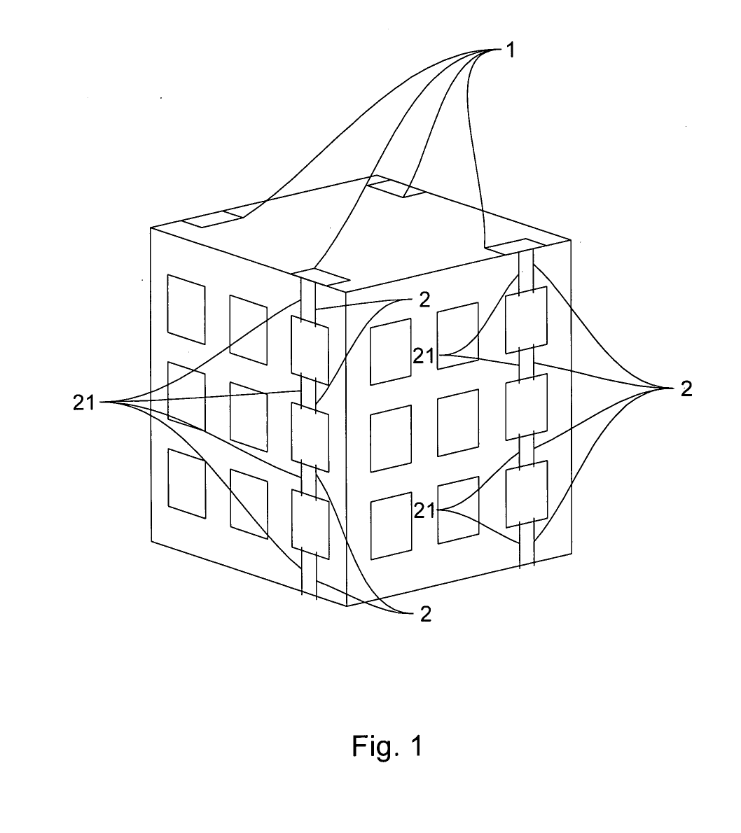

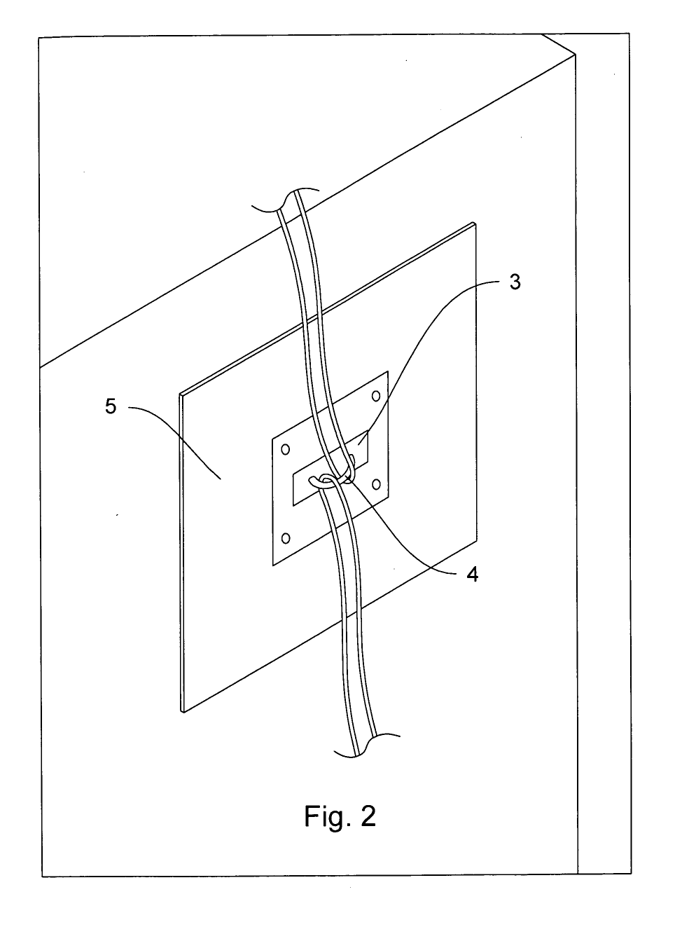

The present invention is a fire escape system for multi-story buildings. The fire escape system described herein employs rappelling equipment strategically placed on the building to allow most efficient escape routes for building occupants. As depicted in FIG. 1, the system comprises rappel anchors attached to the top of a building at each escape point [1], and rappel ropes [2] in addition to rappelling equipment. In this system, rappel anchors, depicted in FIG. 2, are attached to the building at each exit point with mounting hardware [3] which bolt the anchor ring

directly to the building [5]. The rappel ropes [2] are then attached to the anchor either by tying the rope to the anchor or running the rope through the anchor so the midpoint of the rope is at the anchor ring [4] and the two ends of the rope hang down evenly. The preferred embodiment will use the rope tying method. Ropes used are those manufactured and approved for rappelling. These generally are nylon ropes and can be dry rope treated during manufacturing to resist becoming wet because wet ropes can show 30 percent less strength than the same rope when dry. Other coatings or treatments to the rope, for example to improve its fire retardant properties, could be envisioned. The dimensions of the rope would be a standard rappelling rope of 10 millimeters (1 cm, 0.39 in) and 40 meters (120 feet) in length.

The rappel method is the method used to apply friction to the rope to control descent on the rope. There are a few different methods that can be used to rappel; either non-mechanical method or mechanical method. A non-mechanical method wraps the rope around the body in a specific way to apply friction on the rope.

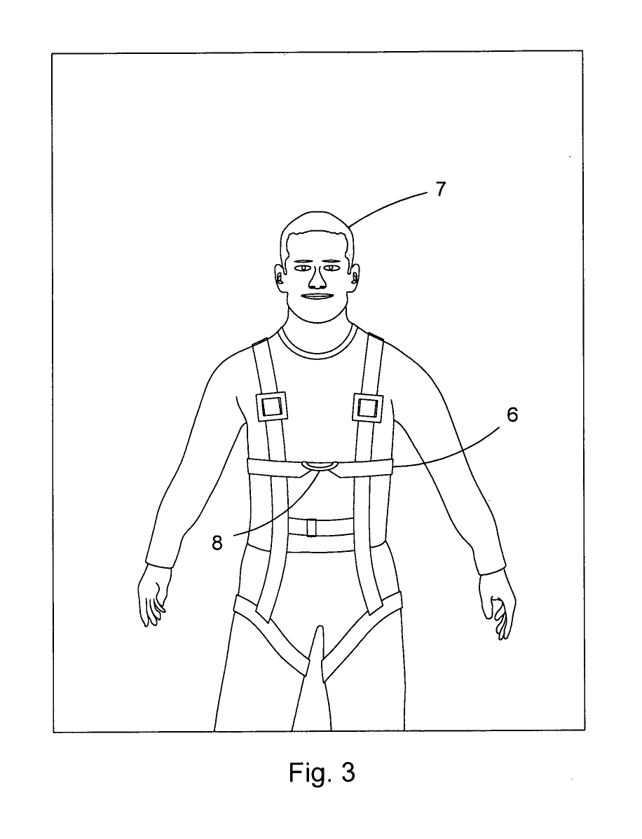

Please refer to FIG. 3. A mechanical method uses a device attached to a body harness [6] worn by the user [7] to apply friction on the rope. There are several devices that can be used for a mechanical method such as a flat aperture, a tube aperture or a figure eight device. The figure eight device is the one that has been in existence the longest and used for the widest variety of uses and will be the one used in the preferred embodiment of the invention.

The user's technique is the way in which the user controls the position of the rope to adjust the friction on the rope to control the rate of descent or come to a complete halt.

In the preferred embodiment, FIG. 1, at a minimum the fire escape system would have an anchor [1] attached to the building at each of the four corners of the rooftop allowing each individual system to utilize the face of each of the four walls of the building. This allows an escape route on each wall in the event one of the walls becomes unusable. This also allows escape from the rooftop should the occupants have to go up for rooftop rescues by aircraft such as helicopters. However, sometimes rooftop rescues are not practical because the fire consuming oxygen creates a drop in air pressure which prevents the helicopter from flying and hovering on a given air pressure. This rooftop escape provision shows the versatility of the system giving every occupant in or on the building an opportunity for escape. This opportunity is not depicted in prior art which can, for example, show a caged animal or harnessed person crashing through a wall. This system of the present invention is then set up so that each window on each floor below the anchor on each corner of the rooftop has an anchor attached to the wall at that window. This allows the occupants to rappel floor by floor down to the ground and overcomes the prior conception that rappelling would not be practical because a rope would be too long to rappel from the top floors of a building down to the ground. The length of the ropes [2] can be adjusted to allow descent from one floor to the next but also can be increased to allow for descent to two or more floors at once in case a lower floor becomes inaccessible during the emergency which further shows the flexibility and adaptability of the system.

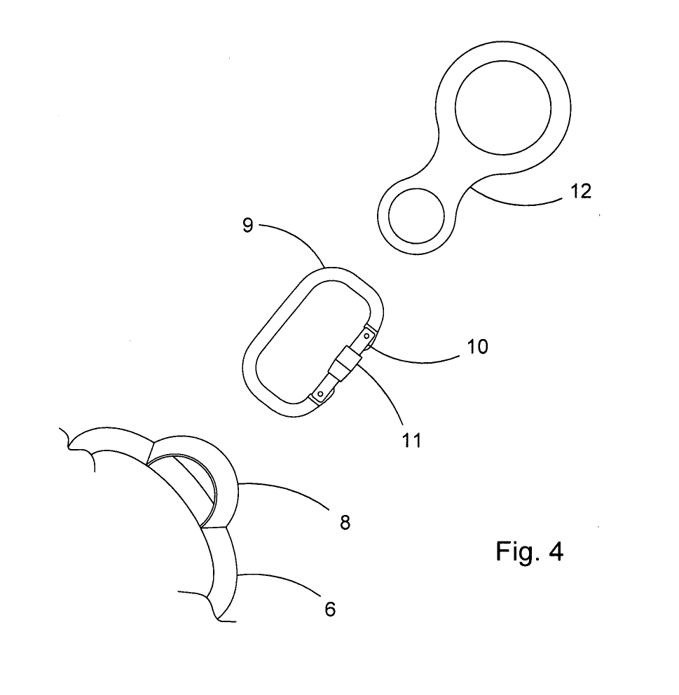

In the event of a fire or other type of emergency that requires immediate evacuation, the occupants proceed to the rooftop or window exit points on each level or floor marked as fire escape exits. FIG. 3 shows a body harness [6] which is used in mechanical rappelling and also has a front loop [8]. The harness [6] is then put on by each evacuee [7]. FIG. 4 shows a carabineer [9] attached to the front loop [8] of the body harness [6]. A carabineer [9] is a hook which comes in different shapes and types. The preferred embodiment will use an oval shape carabineer [9] with an opening gate [10] facing away from the user, or evacuee [7], which automatically closes from being spring loaded at the hinge and is then locked with a locking screw [11]. The figure eight device [12] is than attached to the carabineer [9].

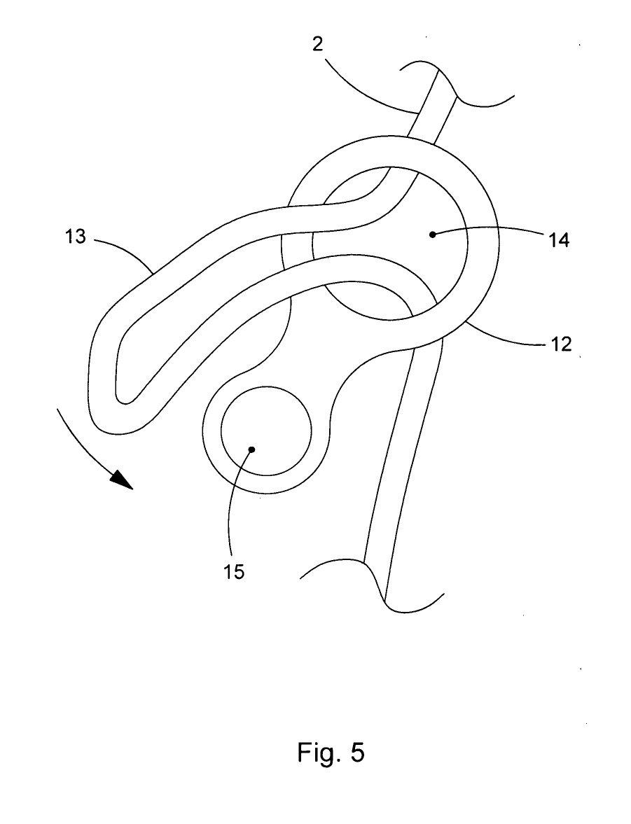

Please refer to FIG. 5. When the evacuee is ready to rappel, the rope [2] is attached to the figure eight [12]. This is done by taking the figure eight [12] which at this point in time would not be attached yet to the carabineer [9] and looping the rope wherein the looped portion of the rope [13] is inserted through the large hole [14] of the figure eight [12] and looped over the end of the figure eight where the small hole [15] is located. The looped rope is then brought under the figure eight and pulled tight.

FIG. 6 shows the small hole [15] of the figure eight [12] is then attached to the carabineer [9 ] which is locked by screwing the locking screw [11] up away from the hinge on the gate [10]. The evacuee is then ready to rappel. The part of the rope or end going up toward the anchor is referred to as the upper rope [16] and the part of the rope or end going down to the descent point is referred to as the lower rope [17]. The rappel technique is then applied to control the descent. The set up and technique can be applied by a right or left handed user. For illustrative purposes, the preferred embodiment will be described for a right handed set up and technique as shown in FIG. 6. The left hand is then be used to hold the upper rope [16] for balance and the right hand holds the lower rope [17] for braking. The right hand is referred to as the braking hand and controls the rate of descent by adjusting the position of the lower rope. Neither hand needs to hold the rope tightly as the rope will be slipping through the hands during descent. The rate of descent or complete halt of the descent is controlled by the friction of the rope on the figure eight [12]. This friction is controlled by the position of the lower rope and is performed by the braking hand. When the lower rope [17] is brought forward and near parallel to the upper rope [16] or close to a zero degree angle to the upper rope [18], the friction is low and the rope is able to slip through the figure eight [12] allowing descent. When the lower rope

is brought back to ninety degree angle to upper rope [16] friction increases and slows descent [19]. When the lower rope [17] is brought all the way back to opposite direction of the upper rope [16] at a one-hundred eighty degree angle to the upper rope [16] the friction is greatest and will halt the descent [20]. This is a simple straightforward one handed operation that does not require any additional strength or knowledge on the part of the user and does not involve any complex technique or operation. The usual recommendation for rappelling is a slow steady descent for optimum control. A slow descent will mean that the rope will be sliding through the hands slowly and will not cause much friction on the hands of the user. If a faster descent is needed the more rapid movement of the rope through the hands could cause more friction and discomfort to the hands. This can be eliminated by wearing gloves.

All the normal safety practices of rappelling would be followed such as tying a knot on the end of the lower rope as a precaution to prevent a user from slipping off the end of the rope and also using window ledges that are rounded to prevent the rope from prematurely fraying. As indicated in FIG. 1 the system could also employ a separate rope [21] from the rappelling rope [2] going from each level to the lower level(s) to allow rappel equipment such as harnesses, carabineers, and figure eights to be sent back up or recycled if not enough rappel equipment had been provided on each level for every evacuee. This also shows the versatility and flexibility of this system to give every occupant of the building an opportunity for escape.

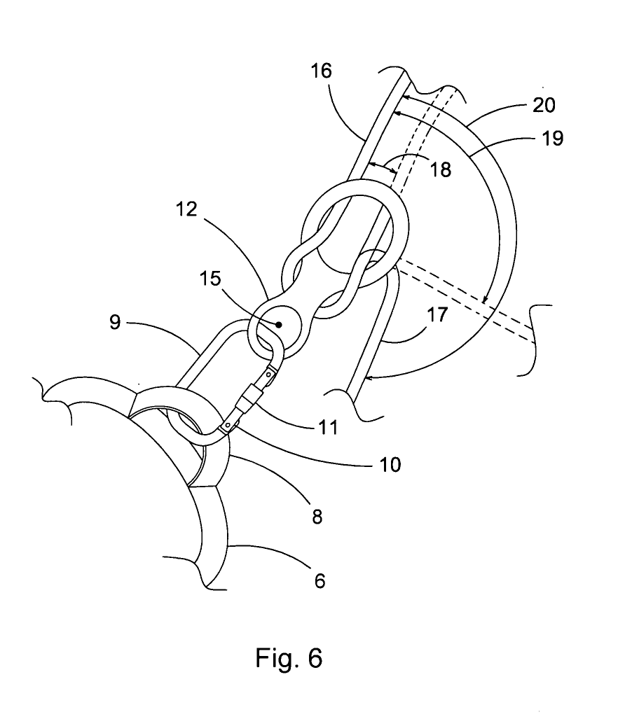

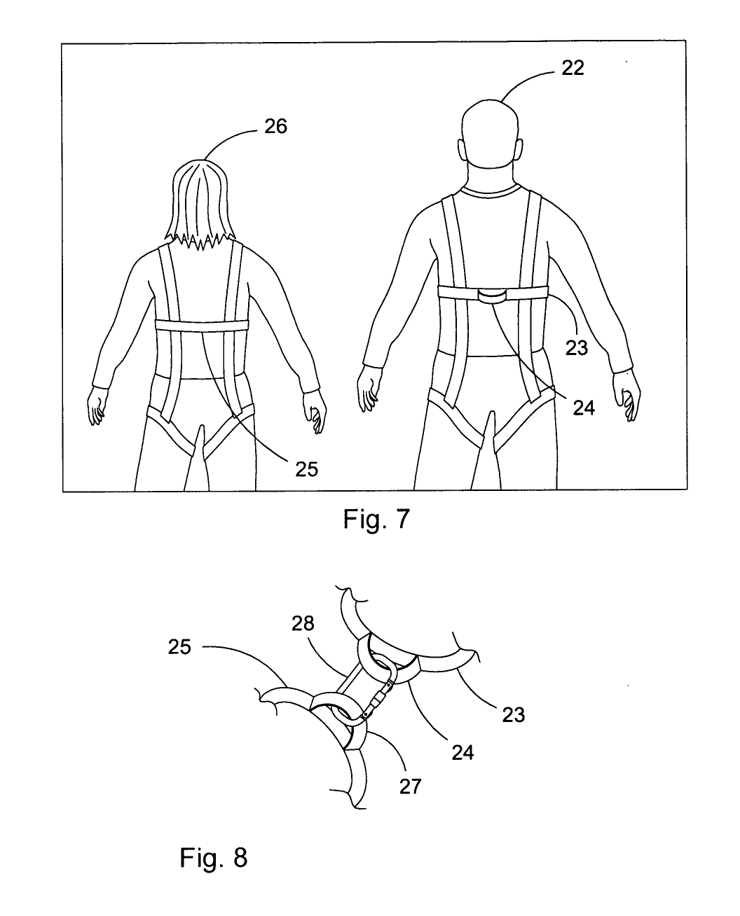

As indicated in FIG. 7, this system would also be able to accommodate handicapped occupants who would not be able to execute a rappel unaided. In most building plans for evacuation, a handicapped person, such as a blind or wheel chair bound occupant, would not be able to negotiate a stairwell and is assigned another occupant to help them out which is known as a buddy system. The procedure would be the same for this system in that only the able bodied adult occupant or “buddy” [22] assigned to help the handicapped person would have a body harness [23] with a loop on the back [24] and an additional harness [25] on the handicapped evacuee [26] attached to the back loop [24] of the buddy to the front loop [27] of the handicapped person's harness [25] by a separate carabineer [28] allowing them to carry the handicapped person on their back as they rappel down. The attachment of the two harnesses is shown in FIG. 8. The combination of the two harnesses is referred to as a double body harness. As an additional option, an extension could be placed over the window ledge and attached to the inside wall with mounting hardware to allow the buddy to free rappel and not touch or bump the wall.

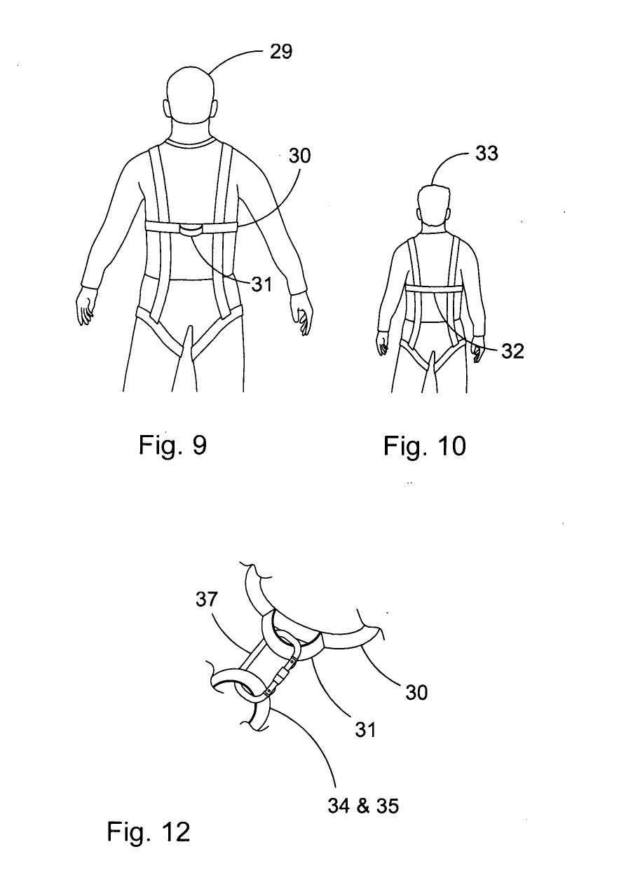

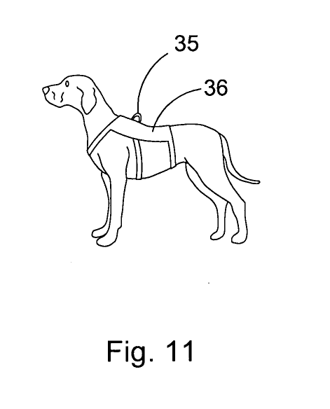

FIG. 9 shows a further embodiment an option for a buddy [29] could use to have a body harness [30] fitted with a loop on the back [31] that would have a second smaller body harness [32] that would be worn by a child [33], shown in FIG. 10, or a different animal harness [36], shown in FIG. 11 to be worn by a pet attached to the back loop of the buddy [31] to the front loop [34] of the child harness [32] or to the top loop [35] of the animal harness [36] by a separate carabineer [37]. This attachment is shown in FIG. 12.

The rappel equipment is capable of being stored in the building at or near the points of exit. The equipment can be secured from tampering or outside weather wear and brought out for use when needed. The equipment can be inspected periodically for good condition. Storage containers can be designed to blend in with the building design and interior.

This system is cost effective and doesn't require extensive building modification or protruding objects which can detract from the building appearance and aesthetic value allowing it to be applied to a multi-story building of any height. This system allows, the evacuees to rappel down the exterior wall until reaching ground level or a floor where it would be safe to exit showing the versatility of the system. This system is also very efficient in that it does not have any negative or wasted motion such as an evacuee waiting for a rope or equipment to be brought back up for use after the previous evacuee completes descent, as seen in prior art. This system can be modified for the building configuration and the exact embodiment desired. This system is an efficient, versatile, flexible and adaptable system and presents an enhancement to the current state of the art of the field of fire escape systems.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described, method, and examples, but by all embodiments and methods within the scope and spirit of the invention.

1. A fire escape system for a user to escape a multi-story building, the building having a plurality of faces, each face having a plurality of stories, the fire escape system comprising:
a plurality of anchors, capable of being attached to each face of the a building, and
one rappelling rope attached to each anchor, each rappelling rope extending from the anchor in a general direction toward the ground,
wherein the user can rappel down the rappelling rope for escape.

2. The fire escape system of claim 1 and further comprising:
an equipment rope secured to each anchor.

3. The fire escape system of claim 1 for use by a handicapped person further comprising:
a double body harness configured for use by two persons secured to the rappelling rope wherein an able bodied person and the handicapped person rappel to safety down the outside of a building wearing the double body harness.

4. The fire escape system of claim 1 for use by a child further comprising:
a double body harness configured for use by two persons wherein an able bodied person and the child rappel to safety down the outside of a building wearing the double body harness.

5. The fire escape system of claim 1 for use by an animal further comprising:
a double body harness configured for use by one person and one animal wherein an able bodied person and the animal rappel to safety down the outside of a building wearing the double body harness.

6. A fire escape system for a user to escape a building having n number of stories, the building having a roof and a plurality of building faces, the fire escape system comprising:
a roof anchor secured to the roof adjacent a building face;
a story anchor secured to the building face at each story; and
a first rappelling rope secured between at least the roof anchor and n story;
wherein the user can rappel down the first rappelling rope for escape.

7. The fire escape system of claim 6 and further comprising:
a second rappelling rope secured between at least the n story and an n-1 story.

8. The fire escape system of claim 7 and further comprising:
a third rappelling rope secured between at least the n-1 story and an n-2 story.

9. The fire escape system of claim 8 and further comprising:
a fourth rappelling rope secured between at least the n-2 story and an n-3 story.

10. The fire escape system of claim 9 and further comprising:
a fourth rappelling rope secured between a second story and a ground surface.

11. The fire escape system of claim 6 and further comprising:
a separate and distinct rappelling rope secured between each adjacent story.

12. The fire escape system of claim 6 wherein the first rappelling rope is further secured between the n story and an n-1 story.

13. The fire escape system of claim 12 wherein the first rappelling rope is further secured between the n-1 story and an n-2 story.

14. The fire escape system of claim 13 wherein the first rappelling rope is further secured between the n-2 story and an n-3 story.

15. The fire escape system of claim 14 wherein the first rappelling rope is further secured at a second story and dangles to the ground.

16. The fire escape system of claim 6 wherein the first rappelling rope is secured at each story from the roof to the ground.

17. The fire escape system of claim 6 and further comprising:
a roof anchor secured to the roof adjacent each building face;

18. The fire escape system of claim 6 and further comprising:
an equipment rope secured to each anchor.
